(19) United States
(12) Patent Application Publication
(10) Pub. No.: US 2011/0137812 A1
(43) Pub. Date: Jun. 9, 2011

(54) SYSTEM AND METHOD FOR MONETIZING AND TRADING ENERGY OR ENVIRONMENTAL CREDITS FROM POLYMERIC MATERIALS

(76) Inventor: Ronald Matthew Sherga, Arlington, TX (US)

(21) Appl. No.: 13/058,533

(22) PCT Filed: Aug. 12, 2009
(86) PCT No.: PCT/US09/53608

§ 371 Date: Feb. 10, 2011

Related U.S. Application Data
(62) Division of application No. 61/089,404, filed on Aug. 15, 2008.
Application No. 61/089,404 is a division of application No. 61/154,606, filed on Feb. 23, 2009.

(51) Int. Cl. G06Q 99/00

(52) U.S. Cl. 705/317

(57) ABSTRACT

The present invention is a system and method for monetizing and trading value in polymeric materials, forming polymer energy credits and/or polymer environmental credits. The system promotes the highest and best use and disposition of polymer waste, scraps and used material. The new types of credits have a value which can be bought, sold and traded in a market exchange. A polymer manufacturer can assign predetermined credit value to polymeric material sent into commerce which can be realized upon disposition of polymeric material in a predetermined or prescribed manner and credited to the manufacturer and/or user of the polymeric material. Alternatively, a verification authority may be implemented to review claims of entitlement to credits and may take into account factors relevant to the polymeric material to assign value to verified polymer energy or environmental credits and/or to certify various entities engaged in the process.

### CROSS REFERENCE TO RELATED APPLICATIONS

This application claims the benefit of U.S. Provisional Patent Application Ser. No. 61/089,404 filed Aug. 15, 2008, and U.S. Provisional Patent Application Ser. No. 61/154,606 filed Feb. 23, 2009.

### STATEMENT REGARDING FEDERALLY SPONSORED RESEARCH OR DEVELOPMENT

Not applicable.

### TECHNICAL FIELD OF INVENTION

This invention relates to the field of systems and methods for monetizing, trading, and tracking environmental or energy credits regarding plastic and polymers.

### BACKGROUND OF THE INVENTION

Plastics are used in a wide variety of products. Plastics are made of polymer materials which many times are not biodegradable. The vast majorities of plastics are made from petroleum based feedstock and contain a high amount of embodied energy which energy is not recovered upon disposal. Disposal of polymer materials may create adverse environmental impact if such waste is put in landfills, or otherwise dealt with in a way that causes excessive air, water or land pollution. Even the recently-touted bio based polymers lack effective end of life solutions. These bio based materials may have even greater harmful green house gas (GHG) emissions when they decay as compared with petroleum based polymers.

While there have been some attempts to deal with polymers by reuse and/or recycling, to date there has been no effective mechanism for capturing intangible value present in the waste material in order to foster an economic incentive to dispose of the waste material in a manner that impacts the environment in a positive manner.

Polymeric materials (including scrap, waste, and items which have been used for their intended purpose and have limited or no further demand) are generated in large amounts. The polymeric materials may not be able to be used “as is” without further processing. Known recovery methods have heretofore been ineffective or so costly that their employment has been restricted or extremely limited. These polymeric materials are currently considered to be massive liabilities to the owners or recipients thereof due to the expense involved in disposing of these materials.

Manufacturers of products which employ polymers are criticized by organizations concerned for the environment for the employment of these materials. For example, the carpet industry in the United States landfills about five (5) billion pounds of such material per year. As another example, it has been estimated that 200 pounds of plastics are used in each automobile but recovery after the useful life of the vehicle is largely ignored. Used plastic bottles, plastic bags and other packaging as well as a myriad of plastic products that do not have an infinite useful life are part of the polymeric materials referred to herein for which disposition issues currently exist. Manufacturers of polymer have hesitated to recycle and reuse polymeric materials to avoid cannibalization of their new polymer products and because of the cost of pursuing the highest and best disposition of polymer based (waste and scrap) materials generated by their processes. One estimate is that two to five percent or less of available polymeric materials is reused.

One of the major expenses faced by entities involved with polymer manufacturer, distribution, use or waste collection is disposal of polymeric materials such as scrap and waste from manufacturing processes and packaging or products that have served their useful life. One of the current approaches to this massive amount of polymeric material is to export it to other countries that have companies or governments willing to accept such material and dispose of it in some way. In order to follow this approach, entities must expend dollars for shipping, handling, outsourcing services, and government fees. The approach also results in the expenditure of fuel for the transportation of the polymeric material overseas or to other remote locations. All of this activity further increase the environmental footprint of the polymer associated with such products. In addition, transportation of such products, most of it to developing countries with little or no environmental regulation, contributes to further degradation of the environment and adverse health impacts.

Since polymers may provide significant beneficial properties to many products, and have in many cases no effective substitute, a need exists to allow the polymer industry to continue to meet the needs of other businesses and consumers, while at the same time providing a method to facilitate the highest and best disposition of polymeric materials. A need exists to reduce the energy wasteful and environmentally questionable approaches currently used to address final disposition of polymers.

### BRIEF DESCRIPTION OF THE DRAWINGS

FIG. 1 illustrates an embodiment of a system of the invention.

FIG. 2 illustrates a hand-held reader for obtaining data from polymeric material equipped with a microprocessor for computation.

FIG. 3 illustrates a computational subroutine which occurs within a computer in the system.

FIG. 4 is a flow chart illustrating the bundle of rights in polymeric material comprising tangible polymer and intangible polymer energy credits and/or polymer environmental credits and a method for exchange of the intangible credits for value.

FIG. 5 illustrates exemplary environmental views of the system and process of the invention

FIG. 6 provides a flowchart for a process detailing verification of credits.

FIG. 7 provides an exemplary use of verification input means associated with polymeric material.

### DETAILED DESCRIPTION

The present invention is a system for monetizing, trading and/or tracking energy or environmental credits created from disposition of polymer waste or scrap materials (hereinafter “polymeric materials”) in a manner which minimizes adverse environmental impact and/or encourages the use of such materials as an energy source. These credits are hereby named “polymer credits” which may be further categorized as “polymer environmental credits” and “polymer energy credits.” Polymeric materials include, inter alia, post-industrial, pre-consumer or post-consumer waste as those terms are used in common parlance. Examples of polymers in polymeric materials are biopolymers, polypropylene (PP), polyethylene (PE), polyamide (Nylon), polyethylene terephthalate (PET), poly(trimethylene terephthalate) (PTT), polystyrene (PS), polylactic acid (PLA), polyvinyl chloride (PVC), CO₂-derived polymers and many specialty plastics including as an example polyetheretherketone (PEEK). In addition, other polymer materials recognized by the Society of Plastics Engineers, the American Chemistry Society the United States Code of Federal Regulations, and/or the ISO (International Standards Organization) in ISO 15270-2008 as a polymer may be processed according to the invention. The present invention provides a system and method by which polymeric material is recognized as a renewable resource.

The polymeric material is monetized into polymer environmental or energy credits by the system of the invention. Entities that have polymer disposition issues will gain valuable polymer environmental or energy credits by identifying and quantifying polymeric material and using the system to transform the material into a bundle of monetized rights comprising tangible and intangible rights which bear a real relationship to the actual handling of the polymeric material. The intangible portion of the bundle of rights comprises polymer environmental credits and/or polymer energy credits. Such credits comprise a new financial instrument which may be bought, sold and traded.

The polymeric material is conceived of according to the system of the invention as comprising a multi-portion bundle of rights—a tangible portion and an intangible portion. According to the system of the invention, the intangible portion is monetized by tracking the fate of the polymeric material itself (tangible portion)—and assigning a value to said intangible portion based upon the tangible portion being directed to a beneficial utility—e.g., recycling, reuse, or energy reclamation rather than being diverted to a nonbeneficial waste product that must be disposed of in some way. Energy and cost expenditures currently employed to deal with disposal issues can be reduced with the use of the present invention because the intangible portion of the value of the polymeric materials can now be realized.

The intangible portion of the polymeric material is monetized according to the system of the invention by assigning a value thereto correlated to the monetary value of use of the material which avoids adverse environmental impact or provides energy. This monetary value is deemed the value of a polymer environmental credit or polymer energy credit. Thus, according to the invention, after monetization of the intangible portion of the polymeric material, the owner of polymeric material is able to trade either the tangible or intangible portion of its bundle of rights, or both. Similar to other tradable credits, the monetary value can rise, stay the same, or go down depending on market conditions, supply, and demand.

Polymer environmental credits are beneficial because they can be traded among entities that have disposition issues related to polymeric materials. Polymer energy credits are beneficial because they can be traded as an asset separate from the tangible energy-generating polymer itself. In addition, the creation of polymer energy credits requires that polymeric materials are staged for use for energy rather than wasted. To put this energy recovery value in context, one ton of coal contains 16 million to 26 million BTUs and is generally considered to cause air pollution when burned as fuel. In contrast, plastics comprise 35-54 million BTUs per ton and burn fairly clean. This provides approximately 15,000 kWh of electricity per ton. Thus, the increased appetite for energy is better addressed by utilizing the system of the invention.

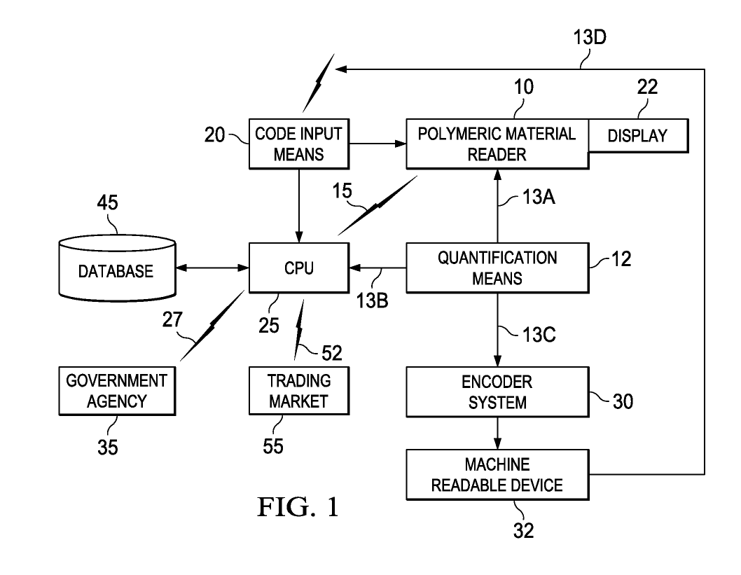

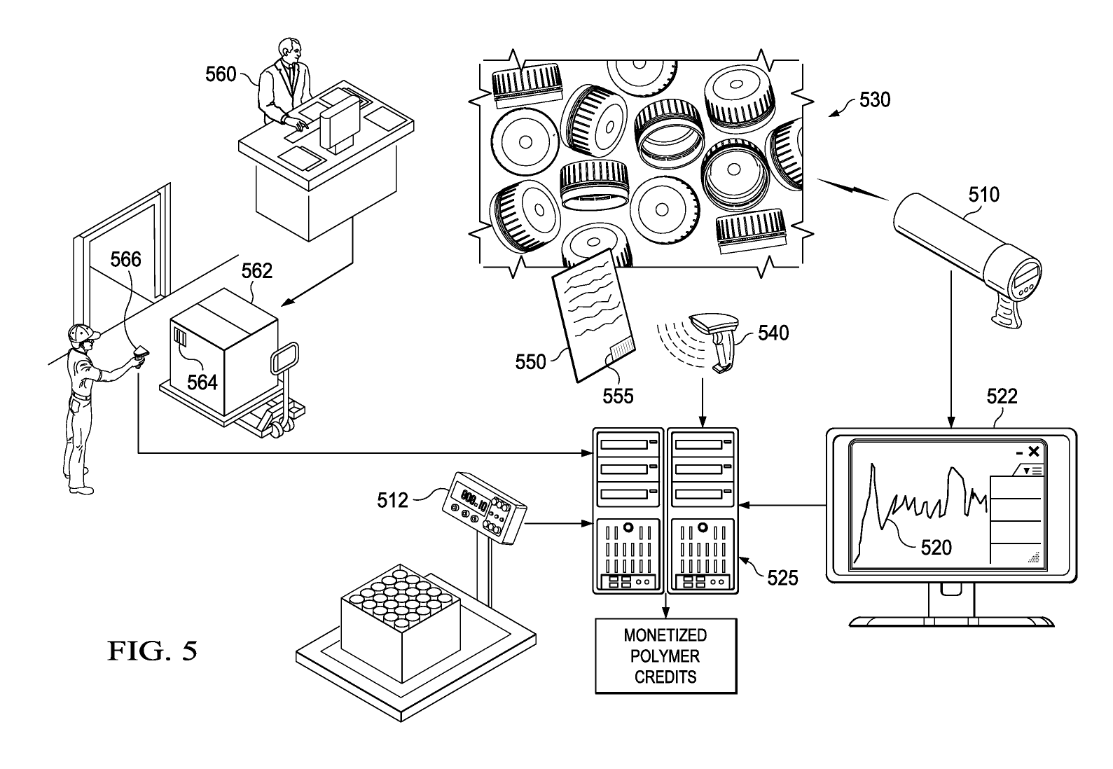

Referring now to FIG. 1, a schematic of a preferred embodiment of the system of the invention is depicted. The system preferably comprises a polymeric material reader device (10) which captures or receives data concerning one or more parameters of interest of given polymeric material such as volume, weight and/or mass of polymer material, owner information, intended fate of the material, type of polymer material and/or previous data on the type of material. One or more polymer reader devices may be used to obtain different types of data, or a single device may be multifunctional and be able to capture all the required data concerning the polymeric material or at least all the data needed in addition to data which has been predetermined. Data captured by reader (10) is transmitted (15) to a central processing unit (CPU) (25) of a computer which contains software or firmware which receives the data and analyzes it as set forth more fully below. One type of reader (10) is a handheld or permanent device which obtains infrared (IR) spectrum data from the polymeric material. This is schematically illustrated in FIG. 5 as item (510), obtaining the spectra of scrap plastic caps illustrated at (530) and transmitting the spectra (520) to a CPU (525). The IR spectrum data is correlated (through computations which occur in the CPU) to a polymer type. Referring back to FIG. 1, another type of reader (10), preferred for dark or black polymeric material, employs spark technology to analyze the nature of the same. In many cases, certain polymer materials are black or dark grey in color and do not react to infra red technology. An example of a spark technology device appropriate for such use is a spectrograph and detector array detecting a Raman spectrum produced by a sample illuminated by a laser source to recognize a variety of materials as described in U.S. Pat. No. 6,310,686. Such device is commercially available (SpectraCode, Inc, West Lafayette, Ind.). Preferably, reader (10) comprises a memory device for storage of data that is obtained through the device or inputted into the device. The data in the memory of reader (10) can be transferred (15) to CPU (25) which has software which can analyze said data for the parameters of interest. The data can be transmitted to the software program through wireless transmission, Bluetooth technology, and/or docked with a computer accessory that can download the information for analysis. In a preferred embodiment, reader (10) is modified to comprise a microprocessor/computational computer comprising analysis software for transforming polymeric material data into polymer environmental and/or polymer energy credits. The system comprises one or more input means for receiving other data concerning the polymeric material under process by the system. The input means can be located in reader (10) and/or CPU (25). An example of input means is a keypad for manual input of information into the microprocessor or computer. The input means can be a wireless communication receiver which can receive information electronically from another device. Such data concerning the polymeric material includes quantity data representing a quantity for the polymeric material being analyzed. Again referring to FIG. 1, the polymeric material can be weighed on a quantification means (12) comprising a scale and the weight inputted manually or transmitted (13A) into reader (10) device which is in communication with the CPU (25) or directly (13B) into the CPU (25). Alternatively, the quantification means comprises a mass estimation via methods used in the art of waste material management and the data inputted or transmitted directly (13B) or indirectly (13A) into the CPU (25). If reader (10) is equipped with a microprocessor, the computations may be done within that microprocessor. Still referring to FIG. 1, in yet another embodiment, an actual value or estimated value for the polymeric material quantity may be transmitted from quantification means (12) via (13C) to an encoder system (30) which encodes the quantity on a bar code or memory chip or other machine readable device (32). For example, a bar code accompanying the polymeric material may be placed on a bill of lading or packing slip which has a verified scale ticket, obtained at a weighing station scale, entered and coded. The bar code can be recognized by a code input means (20) in the system and the data can thus be entered into the microprocessor in reader (10) if so equipped or into CPU (25). Firmware/software programs in the microprocessor or CPU will process the data from the bar code and store the processed information in a memory in reader (10) (not shown) or the database (45). The processed information can be accessed at a later time for information that might be pertinent to client history. The machine readable device preferably will accompany any shipment of the polymeric material so that the data may be read at any point in time as the polymeric material is shipped from point to point. The machine readable device can be placed in proximity (13D) to a code or chip input means (20) which can communicate with reader (10) or CPU (25), thereby transmitting the information thereon to the system. Database (45) is preferably incorporated in the system and stores data concerning IR spectra or other scientific data concerning known polymeric materials. Database (45) may also store data concerning customer accounts and credits accumulated by various customers. Database (45) may store any other known features of a polymer. Data stored in Database (45) may be used by the computational computer to modify a computed value. For example, if data indicates that a polymeric material from a given source historically contains an ash level from talc of 20%, a computation taking into account the ash level could result in an amended value lowering the BTUs by 20%. Upon receipt of input from a reader (10) comprising an IR spectra or other scientific data, and receipt of input from quantification means (12) either directly or through code input (20) concerning a quantity of polymeric material, CPU (25) computes the identity of the polymeric material by comparing the IR spectra or other scientific data to information stored in database (45) which correlates to the identity of the polymer. Reader (10) may be optionally equipped with display (22) and the results of the computation undertaken by CPU (25) may be transmitted to display (22) of reader (10), thus allowing a user to view the identity of the polymeric material. Alternatively, the identity of the polymer may be stored in database (45) and associated with a customer identifier and batch number until further computations are requested. CPU (25) calculates the value of polymer credits (polymer energy credits and/or polymer environmental credits) to which a given customer is entitled pursuant to predetermined values programmed into said system. Immediately or upon a predetermined schedule, the polymer energy credits or polymer environmental credits can be transmitted through electronic communication means (52) to a trading service or market (55). The value of these credits is realized by the exchange of money for such credits, thus providing the customer with funds which were earned by recycling, reuse or energy conversion of polymeric material and the concomitant monetization of the intangible portion of said polymeric material as described above. Alternatively, the number or value of credits may be transmitted through electronic communication means (27) to a government agency (35) which has set up a requirement for credits to be generated by those disposing of polymeric material. This constitutes a compliance mechanism.

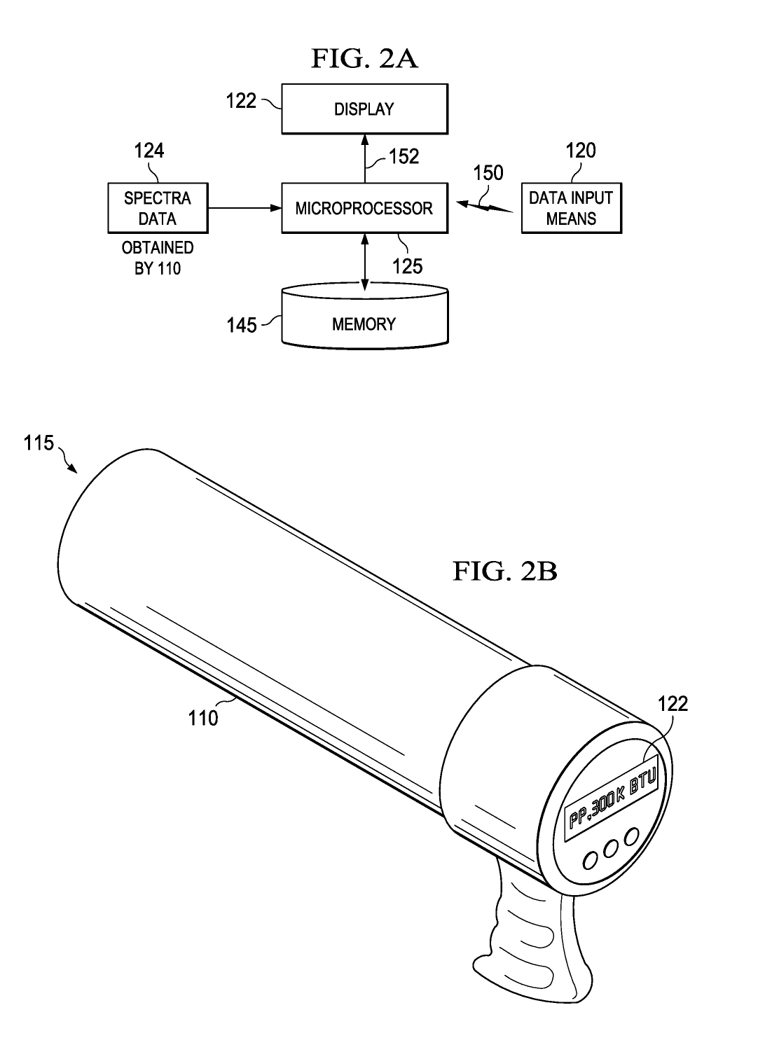

Now referring to FIGS. 2A and 2B, a handheld IR reader (110) as depicted in exemplary form in FIG. 2B may be provided with an onboard system as schematically shown in FIG. 2A. The onboard system comprises microprocessor (125) comprising firmware or software which is able to translate an IR spectrum obtained by the IR reader (110) at optical window (115) from the polymeric material. The microprocessor (125) then correlates the IR spectrum data with predetermined IR spectrums for known polymeric materials stored in memory (145) and transforms the inputted IR spectrum into an output (152) which identifies the nature of said polymeric material. The handheld device may be provided with a display (122) to which the output is directed in a form that can be perceived by the user as to the nature of the polymeric material. For example, an IR spectrum of polymeric material of unknown type can be read by a handheld device and the handheld device microprocessor may correlate the spectra data (124) with predetermined spectra data stored in memory (145) indicating that the unknown polymeric material is polypropylene.

Referring again to FIG. 2B wherein a microprocessor in reader (110) has indicated that unknown polymeric material is polypropylene, (PP) on display (122). Output (152) in FIG. 2A has been communicated to Display (122) shown both in FIG. 2A and FIG. 2B after a computational step has taken place in microprocessor (125) after communication (150) of data to microprocessor (125) from a quantification means (see FIG. 1 (12)) through data input means (120) The computational computer may compute the British Thermal Unit (BTU) value (or any chosen measure of energy) of the PP by comparing values of the unknown polymeric material to known BTU values stored in memory (145) or otherwise made accessible to said computational process. In the case of PP, the computational computer would be enabled through programming to link a value of approximately 30,000 BTUs to each pound of PP. The BTU value may be displayed on a screen on the handheld device if desired. As shown in FIG. 2B, for 10 pounds of PP, 300K BTUs may be calculated, if no other adjustment is needed for impurities. Alternatively, an arbitrary scale can be established which equates a predetermined number of BTUs with an integer value, e.g. (1=60,000 BTUs).

As an alternative to the above, reader (110) of FIG. 2B may transmit data to a remote CPU such as depicted in FIG. 1. Upon completion of computations, the CPU may transmit results back to the reader (110) which may display (122) said results. Although not shown in FIG. 2B, reader (110) comprises a wireless communication means or a means for receiving a data transmission cable or cord which can be attached to other devices for receiving data therefrom or transmitting data thereto. As discussed above, the system of the invention includes computation means for transforming data concerning polymer identity and quantity to a polymer energy credit and/or polymer environmental credit value. Such computation means are selected from a microprocessor located onboard a portable or hand-held field device or a base station computer processing unit (CPU). Polymer credit values are then saved in a database or transmitted to a trader or owner of such materials for commercial purposes. A library of these results can also be accumulated in the database for future reference. This will be helpful in instances where certain materials and waste streams are repeatable and on going, such as industrial sites, large landfill or collection centers. With the added information as to the quantity of polymeric material entered manually or in scanned from a bar code system on a bill of lading or packing slip associated with the shipment of polymeric material (e.g. a verified scale ticket entered and coded), the computational computer can assign a code or polymer energy value or polymer environmental value to the polymeric material. This can be retained in the library or data base and referred to later for similar materials or as a reference for this particular shipment. Once the quantity value is taken into account by the computational computer, a value of interest may be displayed or stored. For example, 40,000 pounds of 20% talc filled PP has a BTU recovery of 960 million BTUs. In the embodiment illustrated in FIG. 2, the reader (110) such as an IR device, spark technology device or other reader device is equipped with an input means (120) which may be equipped to receive manual input of data or to electronically read indicia located on tags or paperwork that are associated with a quantity of polymeric material. Said data can be transmitted to the firmware/software program as described above. Examples of indicia are bar codes, memory chips and the like. A digitized image of polymeric material may be used and transmitted to the central computer as an indicia of the polymeric material as it is shipped from point to point. In another embodiment, the inherent characteristics of the polymer or extraneous substances chemically or physically bonded to the polymer, or admixed therewith, are utilized as tracers or “tags” for the polymeric material. For example, polymers may contain a “chemical signature” or “bio genetic signature” that will allow such materials to be traced back to the original manufacturer using handheld devices capable of reading said indicia or permanent devices located at a location to which the polymeric material is transported. Extraneous substances, for example “tags” such as currently used in explosive materials for tracking origins of the materials, can be introduced by commoners or processors via color additives or other additive packages as the end use requires. Nanotechnology may be employed to provide tags for the polymeric material. As such, a value can be pre-assigned to such materials and coded in for recovery later as the materials enter the waste stream. This will allow producers a clear trail for which they may claim polymer environmental credits and/or polymer energy credits for their materials. In this embodiment, a “cradle to cradle” recovery, reduction and capture process provides the ultimate in carbon disclosure, that is a. maximum tracing of polymeric materials from manufacture to disposition of waste, and incentives are provided for the mode of disposition that will provide the best environmental result and/or use as an energy source since traceable credits can be attributed to the manufacturer who utilizes these advantageous disposition methods for the polymeric material.

Such data, such as from an ash test conducted on a particular shipment, can be entered and stored in the database through the input means.

The reader device (10) in FIG. 1 or (110) in FIG. 2B may be equipped with short range wireless communication technology which permits transfer of information about the polymeric material from a device associated with the polymeric material to the reader device. An example of such technology is Bluetooth® short range wireless technology. Other wireless technology can also be used.

Firmware/software can be modified for individual clients or applications. For example, the software may use inputted or transmitted data to calculate polymer energy credits or polymer environmental credits. These may take into account such factors as energy recovery value, landfill mass or GHG reduction. The resulting calculations or computations can be transmitted to a designated entity. Such entity may be an owner, owner's representative, trader or trading exchange which deals in polymer energy credits and/or polymer environmental credits, or governmental regulatory agency. A library of computations can be accumulated for future reference or conversion to credits and may be useful in situations where certain materials and waste streams are repeatable and ongoing: Examples of ongoing operations are industrial sites, large landfills and polymer collection centers.

The transformation of polymeric material to polymer energy or environmental credit values can be computed in the first instance in metric values or English Standard values.

Preferably, the software comprises a functionality which takes into account various factors of interest in the calculation of polymer environmental credits, such as the amount of landfill space saved by diverting the polymeric material to a higher use, the avoidance of release into the atmosphere of greenhouse gasses (GHG) and/or other factors. In addition, the computational computer can be updated on a daily or even a real time basis to incorporate CO₂ trading values from a trading floor such as CCX or auction site, such as Regional Greenhouse Gas Initiative. Thus, the polymer environmental credit can be determined by use of various data points by the software used by the computational computer.

As just one example, a first entity disposes of polymeric material generated as a result of its manufacturing processes, in a manner that minimizes environmental impact, such as by recycling. Upon processing of the polymeric material by the system of the invention, a value is computed and assigned to the intangible portion of the bundle of rights comprising the polymeric material. This value is equated to a polymer environmental credit. A second entity may also have polymer disposition issues, but it may dispose of its polymer waste in a less effective manner. Such second entity may be interested in purchasing polymer environmental credits from said first entity to offset any penalty it may incur for not disposing of its polymer waste in the most desirable manner.

By encouraging the generation and acquisition of polymer environmental credits, such credits become sought-after and marketable. This encourages entities to use disposition methods which minimize adverse environmental impact in order to generate polymer environmental credits which themselves have economic value. Such created economic value provides incentive for minimizing such adverse environmental activities as using landfills for waste and burning waste which may result in the increase of air pollution, including greenhouse gases, or toxic effects.

Another value placed on polymer waste according to the present invention is polymer energy value. Enormous energy is recoverable from polymer scrap and such energy is traceable and exceeds that recoverable from other materials. In some cases this difference is over 100 times greater than heretofore realized from other materials. The energy efficiency in polymers as fuel is better than wind and current solar capabilities.

Biopolymers have energy value in that they release methane gas therefrom. It is preferred that such bio based polymers are segregated to devoted areas of landfills, or are disposed of in their own landfills or compost type facilities. This will control the release of methane by capture and recovery, preventing its release into the atmosphere. The methane can be used as a source of fuel. In one aspect of the invention, biopolymeric material is transformed into polymer energy credits by actions which result in the capture and/or reuse of methane from biopolymers. One such action is the segregation of biopolymers in a designated zone. Such a designated zone may be a designated area of a landfill, a separate biopolymer-only landfill, or a compost-type facility. Segregation of the biopolymers should be in a manner which controls the release of methane by capture and recovery to prevent release into the atmosphere. Upon verifiable segregation of the biopolymers, transformation into polymer energy credits is initiated by determining or estimating the polymer energy value of the segregated biopolymer as discussed more fully below. The capture and reuse of said methane provides enormous energy recovery and reduces green house gases (GHG reduction potential).

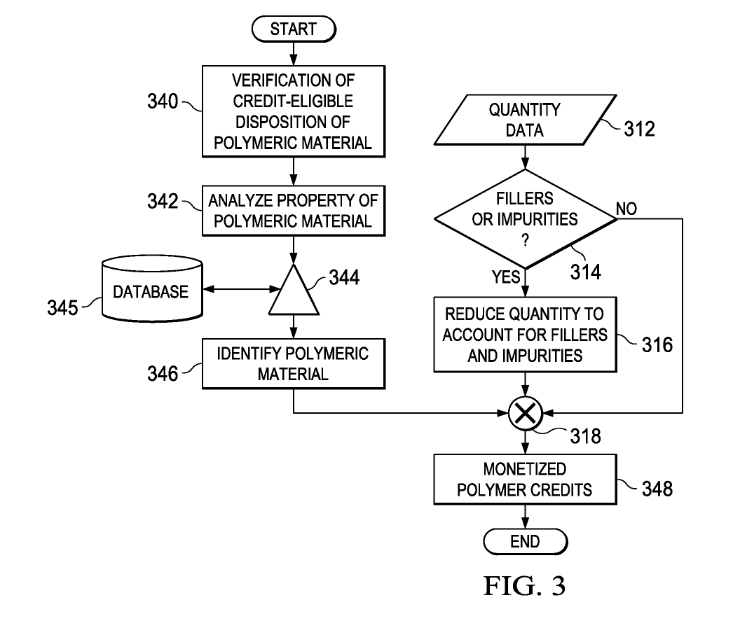

Now referring to FIG. 3 which shows a computation routine programmed into CPU (25) in FIG. 1 or microprocessor (125) of FIG. 2A. In order to determine the polymer energy credit or polymer environmental credit, the quantity or weight of the polymeric material is measured or estimated (312) and manually entered into CPU (25) or electronically transmitted from scale (12), or machine readable tag (32). This weight may or may not include the weight of fillers, additives, or modifiers used in the manufacture of such materials or products. A reasonable value can be assigned by weight (per metric ton or pound) based on the values which are unique to the base polymer type in the material. A test such as a simple ash test to determine fillers and other non-hydrocarbon content can also be performed when it appears or has been disclosed that such additives exist and might adversely effect to a certain degree over 5%, the BTU recovery value. The routine will question if the polymer material has fillers or impurities at query (314), and if yes the routine may reduce the quantity to account for the contribution to the weight of fillers or impurities (316). The quantity value is taken into account at computation (318). If the answer to query (314) is no, the routine will proceed directly to computation (318). The computation also comprises verification of credit-eligible disposition of polymeric material (340), analysis of a property of the polymeric material (342) such as an IR spectra, comparison (344) of the property with information in a database (345), output of identification of the polymeric material (346) which output is taken into account in computation (318), the output of which is monetized polymer credits (348).

If the polymer credit is to be a polymer energy credit, further factors may be taken into account in computation (318). To determine the number of polymer energy credits corresponding to a given weight of polymeric material, one would determine an inherent energy value of polymeric materials. One way to measure the inherent energy value of a polymer material is by BTU content. BTU, which stands for British Thermal Unit, is a measure of the heat that will raise the temperature of one pound of water by one degree Fahrenheit. (One BTU=1054 joules=0.000293 kWh). In order to assign a BTU content to polymer material, one identifies the polymer type which is dominant in the scrap and already-established BTU values can than be applied. If a value has not been established, an independent testing laboratory (such as the University of Akron in Ohio, USA) can determine such values. These values may be stored in database (345) and enter the computation routine at (344). The United States Department of Energy has also determined BTU for various polymers. Table 1 shows some values for plastics which have been estimated per ton.

TABLE 1
Energy Savings and CO2 Impacts
Recycling and Incineration

| | | | | | | Energy | |
|---|---|---|---|---|---|---|---|
| | | | | | | Generated | |
| Energy Savings | | | | | | Per Ton | |
| Per Ton Recycled | | | | | | Incinerated | |
| | | % | | Equivalent | | | Equivalent |
| | | Reduction | Million | in Barrels of | Tons CO2 | Million | in Barrels of |
| Materials | Grade | of Energy* | BTUs | Oil | Reduced | BTUs | Oil |
| Plastic | PET | 57 | 57.9 | 11 | 0.985 | 35.9 | 6.8 |
| | PE | 75 | 56.7 | 10.8 | 0.346 | 35.9 | 6.8 |
| | PP | 74 | 53.6 | 10.2 | 1.32 | 38.5 | 7.3 |

Estimates derived from data supplied by Argonne National Labs (1980, 1981), DOE (1982), Franklin Associates (1990), AL Associates, AISI, Phillips 66, Wellman (1991). Conversions based on data from Love (1974), CRC (1978), Perry (1984), EIS (1990).

In an example, 40,000 pounds of 20% talc filled PP can be computed as a BTU recovery of 960 million BTUs. This can be shown in metric as well. It should be noted that if other factors are taken into account in the computations, the exact values will vary.

As stated above, in the case of dark or black polymeric material, it may be preferred to use spark technology to analyze the nature of the same. In many cases, certain polymer materials are black or dark grey in color and do not readily reflect the Infrared technology. In these cases, a device such as the RP1 manufactured by Spectracode, exemplified in U.S. Pat. No. 6,310,686 may be employed.

According to the invention, the purchaser of polymeric material as defined above may be an entity that actually utilizes the polymeric material, for example to manufacture other products from the material. That purchaser may acquire, in addition to the polymeric material, some or all of the predetermined polymer energy credit and/or polymer environmental credit attributed to the quantity of polymeric material acquired. Such predetermined credit may be coded on a machine-readable tag that accompanies the polymeric material when transferred to the buyer. The seller may chose to reserve a portion of the predetermined credit. In such a scenario, the buyer dictates a polymeric disposal method and the seller agrees to comply with the same. The machine-readable tag may accompany the polymeric material to the disposition site. When the tag reaches the site, the polymeric energy and/or environmental credits may be transferred to the account of the seller, buyer or both. Others may purchase such credits as credits.

By assigning value to the intangible rights inherent in the polymeric material, the seller of such intangible rights now can obtain value therefor. This provides a benefit to society as a whole because this value can generate funds needed to invest in recycling equipment or programs which foster the highest and best use of polymeric material. Municipalities and other taxpayer-funded entities that are often given the responsibility to deal with unwanted polymer waste can benefit from the created economic value. Any expense that is associated with highest and best disposition of polymeric material can be offset by the value of the intangible rights.

With respect to the polymer energy credit, polymeric material can be used or stored and in either case has inherent energy value that can be converted to polymer energy credits that can be sold either with or separate from the polymeric material.

Even though using polymeric material as fuel may create carbon dioxide, generally undesirable from an environmental standpoint, the use of polymeric material for energy may provide advantages when other petroleum based fuels are expensive or in short supply. The polymeric material is already in existence and must be dealt with in some way. It can be thought of as a fuel that has already been “mined” and which offers more energy recovery versus other materials such as virgin coal or other waste such as paper. In addition, methods for converting polymeric material into diesel fuel provide an immediate advantage for vehicles that use such fuel.

Once the BTU content is estimated for the polymeric material at issue, the polymer energy credit is assigned. The polymer energy credit can be in BTU or other units, or a range of BTU units may be equated to a scale or polymer energy credits. For example 1 polymer energy credit may be awarded for a range of BTUs from 1 to 5; 2 from 6 to 10 and so on. Any scale may be developed for this conversion. The nature of the polymer can be used to assign a relative value appropriate for the type of polymer. (See Table 1.) The owner of the polymer energy credit may sell such credits to a buyer in need of such credits. For example, if the buyer has not disposed of its own polymeric material in a manner which preserves the energy potential of such waste in an effective manner, it may need excess credits generated by another entity.

It is contemplated by this invention that an entity, such as a government or financial institution may require or provide an incentive to companies to deal with or otherwise dispose of polymeric material in a prescribed manner. In such case, the present invention provides a means and method to convert polymeric material into a monetized incentive via a bundle of rights comprising tangible and intangible components. The intangible components, comprising polymer environmental credits and polymer energy credits may be exchanged for value.

A computer system exchange will track the buying and selling of such polymer energy credits and/or polymer environmental credits. Such systems are known and used for buying, selling and trading of stocks, carbon credits and the like.

It is envisioned that polymer environmental credits may be converted to other types of credits. Preferably, such conversion will be carried out by a verifying authority who may be a programmed computer which takes into account inputted information or a person to whom the information is submitted. The verifying authority will consider the inherent attributes of the polymer if the polymer environmental credit is to be converted to carbon offset value (carbon offset (also known as carbon dioxide or CO₂ offset). In order to assign a carbon offset value to polymer material, one obtains a sample of such material which represents the dominant polymer type and uses any of a variety of testing methods, such as Infrared spectrometer laser or gas chromatography. Once established, the CO₂ content can be correlated to an arbitrary scale established for polymer environmental credits.

Another type of credit that a polymer environmental credit can be converted to is Green House Gas (GHG) capture. In order to assign a GHG capture to polymer material, one would obtain a sample and follow the procedures using a method to determine GHG content. Some of these methods are mentioned in research performed by CSIRO out of Australia and Argonne National Laboratory in Illinois.

Another type of credit that a polymer environmental credit can be converted to is the volume of landfill space it would occupy if discarded. Thus, using polymeric material that would otherwise be dumped or reusing the polymeric material into a product or as fuel results in a reduction of landfill space. The polymer content only needs to be recognized as a substantial element, preferably a key element, of the item that would otherwise be discarded in a landfill since polymers often appear in association with other materials and together these materials together take up said volume of landfill space. The polymer is a key element of a material if either by weight or volume the polymer represented the primary value of the parts or original product prior to disposal. An example of such a material is carpet. The carpet industry landfills over 5 billion pounds of polymer base materials per year. Studies on carpet disposition issues have been conducted by the Carpet America Recovery Effort (Dalton, Ga.) www.carpetrecovery.org.

The polymer environmental value of these polymer based waste materials and or products, after conversion as described above, can be used as an offset mechanism in the Carbon Trading market, or for Green House Gas (GHG) trading or reduction markets, or as landfill diversion credits, or a combination thereof.

These values can be defined by an independent testing agency or laboratory to verify such values. An average value might also be assigned in order to create a more fungible credit. This assigned “average” value is preferably at least equal to or greater than 50% of a value determined by an independent and non-biased auditing entity or laboratory. The testing agency will be provided a polymer type from the methods results mentioned above and weights certified using standard accounting principles and certified public or private facilities which have scales for such weighing practices. Or such reporting methods as required by the trading platform such as CCX.

The polymer energy credit or polymer environmental credit can then be traded, sold, purchased, bartered or auctioned for economic value. This economic value can be monetary, tax credits, offset value in pollution, climate or carbon trading mechanisms, or to add asset value to a company or group seeking to claim such value for the purpose of adding value to their company or group. These values can also be used for energy efficiency or energy capture as might be used in alternative fuel, or other burning methods to extract heat, or ash.

The trading method requires that the gathered information which has been electronically or manually entered and tracked is then assigned to a particular provider or offset aggregator. It is then entered into a data base or sent electronically or manually to a trading platform where it is received by brokers or providers or aggregators for the purpose of buying or selling such energy or environmental credits.

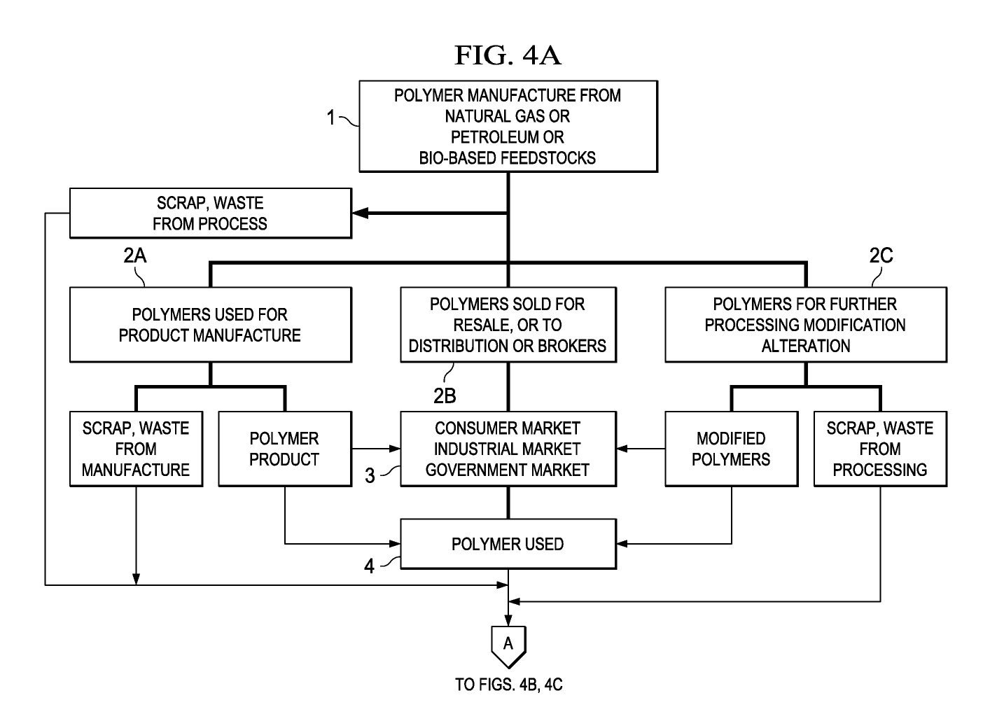

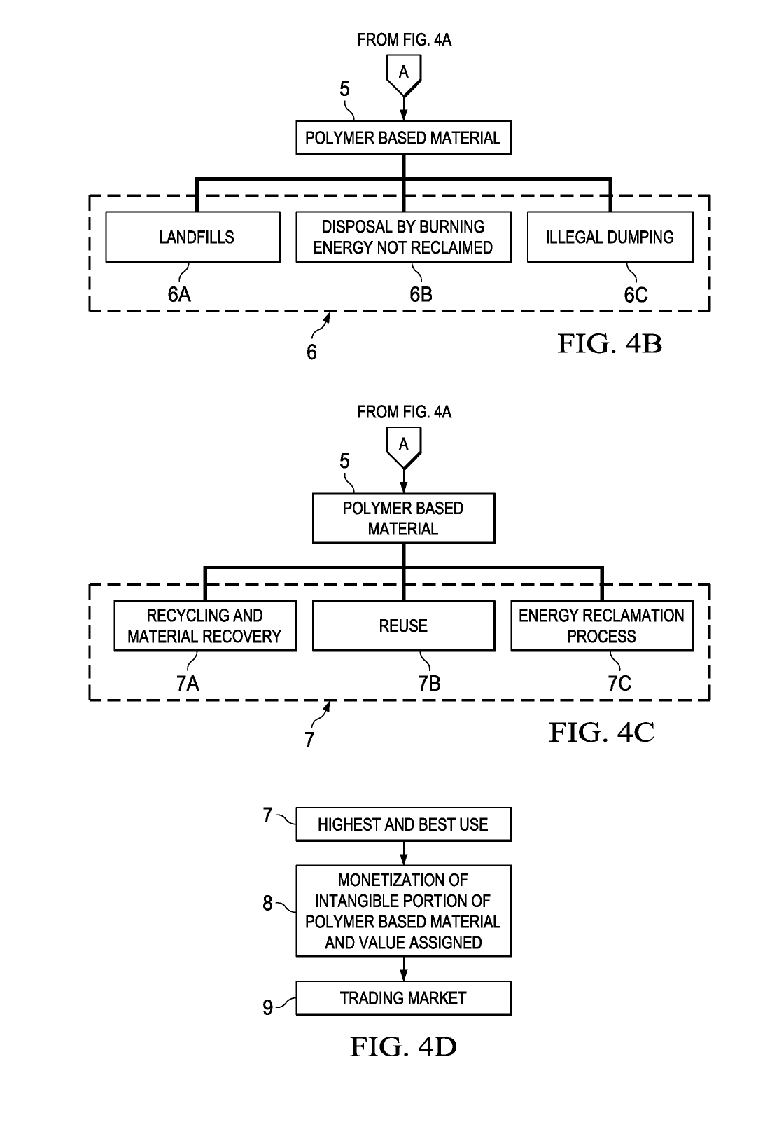

Now referring to FIG. 4A-D, which represents a schematic of the participants in the polymer market and disposition, Box 1 represents the creation of original polymers using natural gas (NG), petroleum or bio-based feedstock. The next step for the original polymers is sale to one of three general categories of buyers. Box 2A represents sale to manufacturers who create a product or part from the original polymers. Box 2B represents sale of original polymers to brokers, resellers, distributors or internal use by the creating entity. Box 2C represents sale to compounders or others that modify, alter to use or resell the polymers. From any of Box 2A, 2B or 2C, the next step is depicted in Box 3, where products made from polymers or scrap polymer from any of the prior steps enter the consumer, industrial or government markets. In addition, polymer scrap or waste can be generated by the processes shown and be directed as indicated. Box 4 represents the product being used by the acquirer. Polygon A represents polymer material from any of the routes depicted, and carries over to FIG. 4A or to FIG. 4B. As illustrated in FIG. 4B or FIG. 4C, Box 5 represents the next step after use wherein the product is sold, discarded, purchased, traded, abandoned, reclaimed or donated. FIG. 4B and FIG. 4C illustrate two different paths from Box 5. FIG. 4B illustrates that from Box 5, the polymeric material may go into landfills for disposition (Box 6A), into a kiln or furnace for disposal by incineration with no energy reclamation (Box 6B), and/or to illegal dumping (Box 6C). Box 6A, 6B and 6C are examples of environmentally unsound disposal encompassed in dashed line Box 6. However, a more environmentally sound approach is for the process instead of going to Box 6 is to follow the pathway illustrated in FIG. 4C, wherein the polymeric material in Box C is diverted to Box 7A (Recyclers, Collectors, Processors), Box 7B (Scrap Yards or Material Recovery Facilities) or Box 7C (Kilns wherein polymer energy is recovered as energy (electricity) or converted into diesel fuel or steam). The Box 7 A-C schematics represent the highest and best possible use (disposition) of the polymeric material. The dashed line indicates that Box 7 A-C are all subsets of Box 7, shown in FIG. 4D.

It should be noted that polymer energy credits may be generated by diverting used polymers, polymer scrap and/or polymer waste to a facility that can convert polymers to fuel (Box 7C). Instead of ending up as a waste product filling up landfills or causing pollution upon disposal, such diversion to fuel provides useful value to the polymers that would otherwise be a burdensome waste product.

Referring to FIG. 4D which illustrates the preferred flow after entering Box 7, polymer environmental or energy credits are recognized as intangible value that can be monetized and a value assigned (Box 8), and then the valued polymer energy credit sent to a market represented by Box 9 where buyers and sellers of polymer credits can buy and sell this asset.

Polymer environmental credits or polymer energy credits can be assigned to the Box 1, 2, 3, 4, or 5 users and a tracking means for such credits utilized according to the method of the invention leading to Box 8 (Asset Recovery). In Box 8, the intangible value can be monetized and a value assigned and then the valued polymer environmental credit sent to a market represented by Box 9 where buyers and sellers of polymer credits can buy and sell this asset. The verifying authority is preferably a computer which has the programming in place to compute the value as previously discussed.

In an alternate embodiment, a tracking means is provided by a verifying authority to entities which agree to channel polymeric material into one of the Box 7A-Box 7C preferred fates. Such tracking means may accompany polymers as they traverse the scheme of FIG. 4. The tracking means can be submitted at a later stage in the polymer disposition fate to the verifying authority which can use this to assign credits and/or certify the entities. The tracking means can be a tangible machine readable code on paperwork that accompanies shipments of polymer as illustrated in FIG. 4 or it can be a computer chip or other tangible device in which intangible value is recorded for later decoding by the verifying authority.

Bales of polymeric material are generally secured by strapping means. It is contemplated that other material may be transported in containers or bags. Tracking means can be secured to said strapping means, containers or bags and polymeric material associated therewith tracked at verification stations. A tracking means can be placed inside a container or bag with the polymeric material which can be machine-read at a final or interim destination for said polymeric material. Examples of tracking means are radio frequency identification (RFID) tags, bar codes, and other machine-readable tracking means. Such a system is similar to the chain of custody tracking used for hazardous waste handling.

In addition to tracking means that can travel with the polymeric material, tracking means may be employed which is made integral with material. A tracking means can be chemically bonded to a polymer and later detected through means appropriate for the type of tracking means. In bio-based polymers, biological markers, including genetic markers, can be used to determine the source of the polymer, and whether polymer environmental credits or polymer energy credits should be awarded to the manufacturer. If a detectable marker is a part of the polymer itself, the credit awards can be awarded based on the actual fate of the polymeric material which is detectable upon being routed to an environmentally desirable fate.

In another embodiment, value is imparted to polymeric material which exists in a mixture of various types of polymers (“polymer mixtures”). Without the necessity of expending labor to segregate the various polymer types in the mixture into like materials.

The polymer mixtures can be baled or otherwise stored, in effect sequestering carbon dioxide or methane which may be otherwise released into the atmosphere. Such polymer mixtures can be used as feedstock for products which suitably may employ mixed materials, such as, for example but not limited to, composite railroad ties, road surfaces and sound barriers. Polymer mixtures can also be used as fuel as discussed above.

Polymer mixtures can be awarded polymer environmental and/or energy credits in the method of the invention as described for the pure polymeric material. By providing value to polymer mixtures, there is incentive to capture, mine and store polymer mixture materials until such time as feedstock or fuel is needed.

FIG. 5 illustrates some exemplary scenarios. Computer main frame or CPU (525) receives data from one or more sources concerning polymeric materials. Software in (525) monetizes polymeric materials by either determining the identity of the polymeric material from a spectra (520) (shown here displayed on display means (522)) obtained by reader (510) from scrap material (530) or receiving pre-determined identity data determined in an onboard computer located in reader (510). Shipping paperwork (550) accompanying scrap material (530) may have a machine readable device or code (555) which has information concerning the scrap material which may be read by device (540) and transmitted or inputted to computer (525). Paperwork (550) may contain any data predetermined for the scrap material such as identity, weight, identity of participating manufacturers or product fabricators. If the identity has not been predetermined, then reader (510) may be used to do so. Also depicted is quantification means (512) which in this example is an industrial scale on which a container of polymeric material may be weighed. This quantity data is then transmitted or inputted to (525).

Another example scenario, also depicted in FIG. 5 is the employment of the system of the invention by participating manufacturers, represented by (560). In this case a participating manufacturer (560) of polymeric materials marks new raw material (here shown contained in box (562)) with a machine readable device (564) which is encoded with the identity of the manufacturer and the preplanned route for polymers sold by the participating manufacturer, which referring to FIG. 4A are represented by Boxes 2A, 2B or 2C. A code input means at (566) is used to track the shipment of polymeric material when it leaves the participating manufacturer (560) and when it arrives at the site of a participating user (not shown in FIG. 5, but depicted schematically in FIG. 4A at 2A, 2B or 2C. This tracking data provides a verification that any scrap or waste will be diverted to the process depicted in FIG. 4C. Most preferably, paperwork or a machine readable device accompanies any shipment of scrap or waste as show in FIG. 4A. A code input device is physically located at authorized facilities where recycling (7A), reuse (7B) or energy reclamation (7C) occurs and this encoded data accompanying incoming shipments of polymeric material is read and inputted for immediate or later transmission to a centralized computer system (525) as shown in FIG. 5.

It is not required that the polymer committed to 7A, 7B or 7C emanate from a participating manufacturer. However, should a manufacturer desire to obtain polymer energy or polymer environmental credits, the system of the invention allows for verification and monetizing of intangible rights associated with the polymeric material. Others (such as depicted in FIG. 4A at Boxes 2A, 2B, 2C, 3 or 4) may utilize the system of the invention by ensuring that polymeric material is shipped to authorized recipients 7A, 7B or 7C.

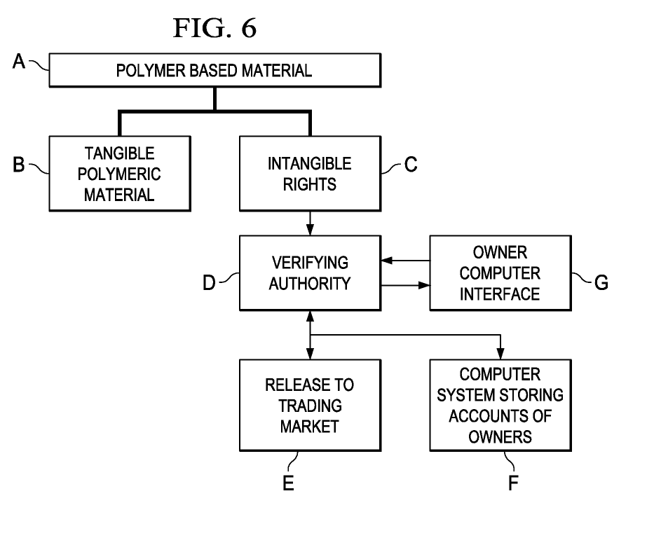

Now referring to FIG. 6, Box A refers to a polymeric material which is divided into Box B tangible polymeric material and Box C intangible rights comprising polymer environmental credits and/or polymer energy credits. These credits are accounted for and transmitted to a verifying authority Box D, wherein the credits are verified from information submitted by the owner or holder of the credits. In a preferred embodiment, a verifying authority reviews the claimed credits and associates a verification indicia (monetized value) with verified credits. The system comprises a verifying authority data input means, whereby input verifying the location of a quantity of disposed polymeric material can be made manually or via the reading of a tag, bar code or the like which accompanies the disposed polymeric material. This input at a site authorized by a verifying authority serves as confirmation that said quantity of disposed polymeric material is staged for reuse, recycling or conversion to energy. The verifying authority, preferably comprising a computer system having a program for monetizing the intangible rights, may be equipped with an owner computer interface so that the owner of credits may access information stored by the verifying authority. The verifying authority may also be in electronic communication with trading markets and/or with another computer system which stores information on accounts of owners.

Preferably, the system of the invention includes sites approved for use and disposition of polymeric material in a manner which complies with predetermined criteria will scan information accompanying the polymeric material shipment as it travels from point to point, for example upon shipment of new material from the maker to a manufacturer of plastic items, to a site for waste or scrap reuse, recycling or conversion to energy. At each of these points, the shipment documentation may be scanned into the system, verifying that the material has arrived at the approved destination and is therefore the intangible rights are eligible for monetization into polymer energy or environmental credits.

The verifying authority may take into account the source and quantity of the polymeric material to determine if credits are warranted and if so the value of such credits. Verified credits can be released into a trading market for purchase by others as illustrated in FIG. 6 (Box E). These verified credits can also be sent to a computer system or database (Box F) which tracks the polymer credit accounts of the owners. At a later time, these credits may be submitted to the trading market (Box E) or submitted back to the verifying authority (Box D) for conversion into another type of credit. In a preferred embodiment, an online system is accessible on the World Wide Web through a computer interface. An online submission form is preferably provided at owner computer interface (Box G) that can be completed by an entity seeking verification of claimed credits and/or for qualification as a supplier or buyer of such verified credits. The verification authority may be programmed to recognize criteria for verification and either review or request review of back up documentation showing the polymer source, type, weight and any other values by sending communication requests to the owner computer interface

The verified credits may be converted into other types of credits which have already been recognized in trading markets, such as offset of carbon dioxide equivalents, by using chemical and physical data relevant to the polymeric material either measured with respect to the actual material or estimated from known properties of the material. In such case, the verification authority may provide an interface with such trading markets so that users of the system can forward the converted credits to a trading market of choice and/or request the verification authority to so.

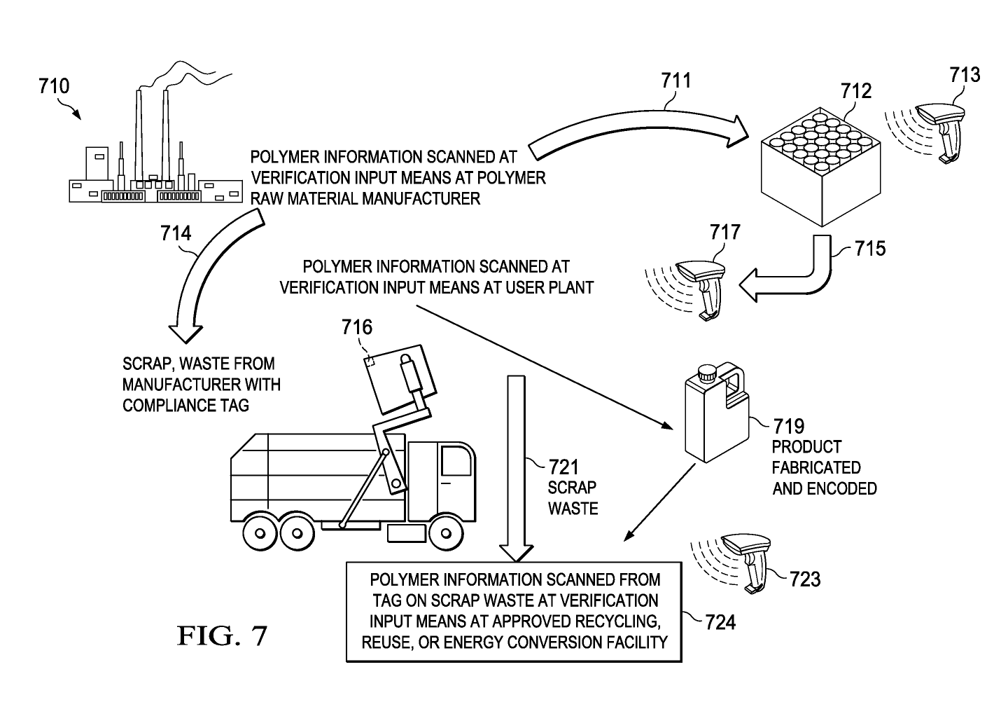

Referring to FIG. 7, an exemplary system is depicted wherein polymer information is obtained as the polymer material is manufactured, used to fabricate products, and disposed of. If a polymer raw material manufacturer (710) decides to participate in the system of the invention, it may participate with respect to sending (714) its scrap and waste material to an approved recycling, reuse or energy conversion facility (724) and/or by participating with respect to its end product, polymer raw material. In the case of sending scrap and waste to an approved facility, a compliance tag (716) will accompany shipments. As shown, tag (716) can be affixed to containers of scrap and waste and preferably will be encoded with the identity of the participating manufacturer, identity of the polymer, and other information that may be useful. Tag (716) may also accompany shipping documents rather than be physically fixed to a container, may be in a container, or may be affixed to the polymer. Tag (716) could also be a characteristic of the polymer itself as described above. In such case at Polymer raw material manufacturer (710), information about the polymer material is preferably encoded (711) into the product or onto a machine readable code which accompanies the product (712). Scanning (713) may be used to decode this information and transmit it to the verifying authority. As product (712) is shipped (715) to a participating user manufacturer and received, it may be scanned into verification input means (717). Upon scanning into verification input means, the fact of arrival at a participating user manufacturer preferably is transmitted to the verifying authority. The participating user manufacturer may encode the products (719) it makes from the polymer raw material and also encode the scrap and waste (721) with a machine readable device. If either encoded product (719) or scrap waste (721) arrives at an approved recycling, reuse, or energy conversion plant (724), the machine readable code can be scanned (723) and the fact of arrival transmitted to the verifying authority. By providing a means to verify the occasions that polymer material is routed through entities that are disposing of polymer scrap and waste through approved channels, and transmitting this verification to a verifying authority, each entity can accumulate polymer credits awarded by the verifying authority.

The system can be used by any participating entity, regardless of the participation or non-participation of suppliers to that entity. For example, a user of raw polymeric materials that manufactures plastic bottles may participate in the system even if the raw material manufacturer does not.

In an alternative embodiment, a specific trading market for polymer environmental and/or polymer energy credits is used for buying, selling or trading verified credits.

In another aspect of the method of the invention, creation and/or acquisition of verified polymer environmental or energy credits allows an owner thereof to acquire a certification from the verifying authority attesting to the owner's engaging in or supporting the highest and best disposition of polymeric material, in other words that which keeps such material out of landfills and fates having an adverse environmental impact and/or use as an energy source. In another aspect of the method of the invention, the owner thereof complies with existing or future governmental mandates with respect to polymeric material. The verifying authority takes into account information requested from the entity desiring certification which supports the entity's participation in engaging in or supporting the highest and best disposition of polymeric materials.

I claim:

1. A system for monetizing disposed polymeric material, said system comprising a reader for analyzing a physical property of a quantity of disposed polymeric material, a computer processing unit (CPU) capable of receiving data from said reader, a database in communication with said computer processing unit which contains physical property data concerning known polymeric materials, a program for comparing the physical property from said disposed polymeric material with the physical property data and thereby determining the identity of said disposed polymeric material and upon input of quantity information for said quantity of disposed polymeric material, computing a polymer environmental credit value or a polymeric energy credit value for said disposed polymer.

2. The system of claim 1, wherein said CPU is programmed to associate said credit values with a customer identity, and wherein said associated credit values, and said associated credit values are stored in said database.

3. The system of claim 1, wherein said CPU is programmed to associate said credit values with a customer identity, and wherein said associated credit values, and said associated credit values are sent electronically or manually to a trading platform.

4. The system of claim 1, further comprising a verifying authority data input means, whereby input verifying the location of said quantity of disposed polymeric material is made, which input is electronically communicated to a verifying authority, which input serves as a confirmation to said verifying authority that said quantity of disposed polymeric material is staged for reuse, recycling or conversion to energy.

5. A method for monetizing polymeric materials, comprising providing a verifying authority with information on a quantity of polymeric material which has been disposed of in a pre-approved manner, thereafter said verifying authority approving or disapproving the issuance of polymer credits.

6. The method of claim 5, wherein said polymer credits are converted to recognized credits traded in pre-existing markets.

7. The method of claim 6, wherein said polymer credits are transferred to a market where they may be sold or traded.

8. The method of claim 5, wherein said polymer credits are used by said verifying authority to determine if an applicant is entitled to certification.

9. A polymer credit comprising a monetary value assigned to an intangible portion of a polymer quantity, said polymer quantity comprising an intangible portion and a tangible portion.

10. The polymer credit of claim 9, wherein said monetary value is assigned by a computer system after verification that a pre-approved disposal method was used for said tangible portion.

11. The polymer credit of claim 9, wherein said monetary value is assigned by a computer system after verification that said tangible portion was converted into energy using a pre-approved method.
